(19) United States
(12) Patent Application Publication
(10) Pub. No.: US 2026/0127712 A1
(43) Pub. Date: May 7, 2026

(54) MULTI-FRAME EDGE-ENHANCED DEGHOSTING

(71) Applicant: Samsung Electronics Co., Ltd., Suwon-si (KR)

(72) Inventors: Weidi Liu, Frisco, TX (US); Gunawath Dilshan Godaliyadda, Allen, TX (US); Nguyen Thang Long Le, Garland, TX (US); John W. Glotzbach, Allen, TX (US); Hamid R. Sheikh, Allen, TX (US)

(21) Appl. No.: 18/940,561

(22) Filed: Nov. 7, 2024

(51) Int. Cl. G06T 5/50; G06T 5/30; G06T 5/70; G06T 5/73; G06T 7/246

(52) U.S. Cl. CPC G06T 5/50; G06T 5/30; G06T 5/70; G06T 5/73; G06T 7/248; G06T 2207/20192; G06T 2207/20201; G06T 2207/20208; G06T 2207/20221

(57) ABSTRACT

A method includes selecting a reference frame and a non-reference frame from a plurality of image frames. The method also includes generating a reference edge map identifying edges in the reference frame and a non-reference edge map identifying edges in the non-reference frame. The method further includes generating a moving edge map based on one or more movements between one or more of the edges of the reference edge map and one or more of the edges of the non-reference edge map. The method also includes generating a blend map based on the reference and non-reference frames. The method further includes modifying the blend map based on one or more indications of movement of corresponding pixels in the moving edge map to generate a modified blend map. In addition, the method includes blending the reference and non-reference frames based on the modified blend map to generate an output image.

### TECHNICAL FIELD

This disclosure relates generally to image processing. More specifically, this disclosure relates to multi-frame edge-enhanced deghosting.

### BACKGROUND

Many mobile electronic devices, such as smartphones and tablet computers, include cameras that can be used to capture still and video images. In some cases, an electronic device can capture multiple low dynamic range (LDR) image frames of a real-world scene at different exposure levels and blend the LDR image frames to produce a high dynamic range (HDR) image of the real-world scene. This process is often referred to as multi-frame processing (MFP). The resulting HDR image generally has a larger dynamic range than any of the individual LDR image frames. Among other things, blending the LDR image frames to produce the HDR image can help to incorporate greater image details into both darker regions and brighter regions of the HDR image so that the HDR image can preserve details of the real-world scene. Moreover, noise in the HDR image can be mitigated based on an analysis of the noise profiles for all of the LDR image frames, resulting in less noise in the HDR image.

### SUMMARY

This disclosure relates to multi-frame edge-enhanced deghosting.

In a first embodiment, a method includes selecting, using at least one processing device of an electronic device, a reference frame and a non-reference frame from a plurality of image frames. The method also includes generating, using the at least one processing device, a reference edge map identifying edges in the reference frame and a non-reference edge map identifying edges in the non-reference frame. The method further includes generating, using the at least one processing device, a moving edge map based on one or more movements between one or more of the edges of the reference edge map and one or more of the edges of the non-reference edge map. The method also includes generating, using the at least one processing device, a blend map based on the reference frame and the non-reference frame. The method further includes modifying, using the at least one processing device, the blend map based on one or more indications of movement of corresponding pixels in the moving edge map to generate a modified blend map. In addition, the method includes blending, using the at least one processing device, the reference frame and the non-reference frame based on the modified blend map to generate an output image.

In a second embodiment, an apparatus includes at least one processing device configured to select a reference frame and a non-reference frame from a plurality of image frames. The at least one processing device is also configured to generate a reference edge map identifying edges in the reference frame and a non-reference edge map identifying edges in the non-reference frame. The at least one processing device is further configured to generate a moving edge map based on one or more movements between one or more of the edges of the reference edge map and one or more of the edges of the non-reference edge map. The at least one processing device is also configured to generate a blend map based on the reference frame and the non-reference frame. The at least one processing device is further configured to modify the blend map based on one or more indications of movement of corresponding pixels in the moving edge map to generate a modified blend map. In addition, the at least one processing device is configured to blend the reference frame and the non-reference frame based on the modified blend map to generate an output image.

In a third embodiment, a non-transitory machine-readable medium contains instructions that when executed cause at least one processor to select a reference frame and a non-reference frame from a plurality of image frames. The non-transitory machine-readable medium also contains instructions that when executed cause the at least one processor to generate a reference edge map identifying edges in the reference frame and a non-reference edge map identifying edges in the non-reference frame. The non-transitory machine-readable medium further contains instructions that when executed cause the at least one processor to generate a moving edge map based on one or more movements between one or more of the edges of the reference edge map and one or more of the edges of the non-reference edge map. The non-transitory machine-readable medium also contains instructions that when executed cause the at least one processor to generate a blend map based on the reference frame and the non-reference frame. The non-transitory machine-readable medium further contains instructions that when executed cause the at least one processor to modify the blend map based on one or more indications of movement of corresponding pixels in the moving edge map to generate a modified blend map. In addition, the non-transitory machine-readable medium contains instructions that when executed cause the at least one processor to blend the reference frame and the non-reference frame based on the modified blend map to generate an output image.

Any one or any combination of the following features may be used with the first, second, or third embodiment. The edges of the reference edge map and the edges of the non-reference edge map that have a length below a threshold can be filtered. The one or more movements can be identified based on a non-zero area of a difference between corresponding edges of the reference edge map and the non-reference edge map. For each identified movement of a respective pixel in the moving edge map, a pixel value for the respective pixel in the blend map can be multiplied by an edge score in the moving edge map to generate a corresponding pixel value for the respective pixel in the modified blend map. For each static pixel identified in the moving edge map, a pixel value can be maintained for the static pixel in the modified blend map. A second non-reference frame may be selected from the plurality of image frames, and a second non-reference edge map identifying edges in the second non-reference frame can be generated. A second moving edge map can be generated based on at least one movement between at least one of the edges of the reference edge map and at least one of the edges of the second non-reference edge map. A second blend map can be generated using a deghosting produced on the reference frame and the second non-reference frame. The second blend map can be modified based on at least one indication of movement of corresponding pixels in the second moving edge map to generate a second modified blend map. Blending the reference frame and the non-reference frame can include blending the reference frame, the non-reference frame weighted by the modified blend map, and the second non-reference frame weighted by the second modified blend map. A final blend map for the non-reference frame can be generated by selecting a final pixel value for a respective pixel based on a highest pixel value between (i) a pixel value of the respective pixel in the modified blend map and (ii) a pixel value of the respective pixel in a modified blend map of an adjacent non-reference frame. The non-reference frame can be blended by a weighting of the final blend map. Dilation on the moving edge map of the non-reference frame and the moving edge map of the adjacent non-reference frame can be performed to determine an intersection area value, and the final pixel value can be multiplied by the intersection area value.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings:

FIG. 1 illustrates an example network configuration including an electronic device in accordance with this disclosure;

FIG. 2 illustrates an example multi-frame processing pipeline that supports multi-frame edge-enhanced deghosting in accordance with this disclosure;

FIG. 3 illustrates an example deghosting operation in the multi-frame processing pipeline of FIG. 2 in accordance with this disclosure;

FIG. 4 illustrates an example moving edge detection function in the deghosting operation of FIG. 3 in accordance with this disclosure;

FIGS. 5A and 5B illustrate example results obtainable using multi-frame edge-enhanced deghosting in accordance with this disclosure; and

FIG. 6 illustrates an example method for multi-frame edge-enhanced deghosting in accordance with this disclosure.

### DETAILED DESCRIPTION

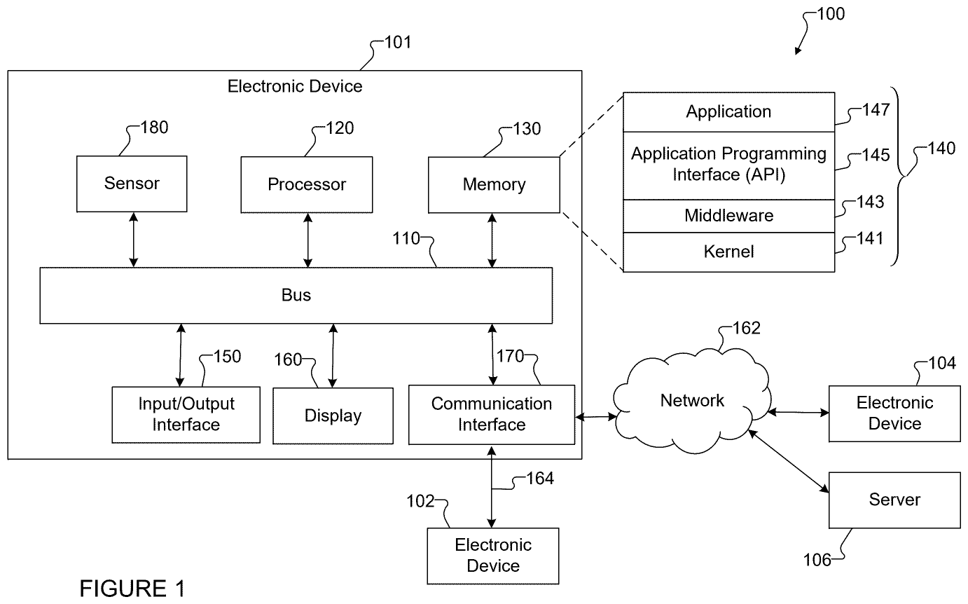

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure.

As noted above, many mobile electronic devices, such as smartphones and tablet computers, include cameras that can be used to capture still and video images. In some cases, an electronic device can capture multiple low dynamic range (LDR) image frames of a real-world scene at different exposure levels and blend the LDR image frames to produce a high dynamic range (HDR) image of the real-world scene. This process is often referred to as multi-frame processing (MFP). The resulting HDR image generally has a larger dynamic range than any of the individual LDR image frames. Among other things, blending the LDR image frames to produce the HDR image can help to incorporate greater image details into both darker regions and brighter regions of the HDR image so that the HDR image can preserve details of the real-world scene. Moreover, noise in the HDR image can be mitigated based on an analysis of the noise profiles for all of the LDR image frames, resulting in less noise in the HDR image.

Unfortunately, it is common for one or more objects within a scene to have some degree of motion during image capture. In some cases, this may be due to actual movement(s) of the object(s) within the scene, such as when people or vehicles are themselves moving or when wind is blowing leaves or other foliage. In other cases, this may be due to motion associated with the electronic device itself, such as due to hand motion or other camera motion. A combination of these motions is also common. If LDR image frames are simply blended together, these movements can lead to the creation of ghosting artifacts or other blurring artifacts in a resulting HDR image.

Current deghosting algorithms can suffer from various shortcomings. For example, objects with finer textures that exhibit small amounts of motion within a scene (such as foliage) may be harder to detect, and incomplete or inaccurate motion detection can cause a loss of detail and the creation of ghosting or other blurring artifacts. As another example, the detection of motion areas may be based on pairwise information across two LDR image frames, but this approach can fail due to unpredictable reasons in certain scenarios, such as motion blur that occurs in a single LDR image frame due to its associated exposure time or an unexpected environmental light level change.

This disclosure provides various techniques for multi-frame edge-enhanced deghosting. As described in more detail below, a plurality of image frames (such as multiple LDR image frames) can be obtained, and a reference frame and a non-reference frame can be selected from the plurality of image frames. A reference edge map identifying edges in the reference frame can be generated, and a non-reference edge map identifying edges in the non-reference frame can be generated. A moving edge map can be generated based on one or more movements between one or more of the edges of the reference edge map and one or more of the edges of the non-reference edge map. A blend map can be generated based on the reference frame and the non-reference frame (such as by using a deghosting process), and the blend map can be modified based on one or more indications of movement of corresponding pixels in the moving edge map to generate a modified blend map. The reference frame and the non-reference frame can be blended based on the modified blend map to generate an output image (such as an HDR image). For instance, the non-reference frame weighted by the modified blend map may be blended with the reference frame. In some cases, a second non-reference frame may be selected; a second non-reference edge map, a second moving edge map, and a second blend map may be generated; and the second blend map may be modified to generate a second modified blend map. The reference frame may be blended with the non-reference frame weighted by the modified blend map and the second non-reference frame weighted by the second modified blend map.

In this way, the described techniques can more accurately account for motion within captured image frames when performing deghosting or other image processing operations. For example, moving edge detection can be performed during deghosting or other image processing operations for better motion detection. This can be useful or desirable in a number of circumstances, such as those in which scenes being imaged include foliage or other objects with finer textures. Moreover, in some cases, the described techniques can be used across image frames (such as three image frames) to improve moving object detection, which can help to further improve deghosting or other image processing operations. As a result, HDR images or other images generated by the image processing operations can have reduced or minimal ghosting artifacts or other blurring artifacts.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described below, the processor 120 may obtain and process image frames in order to perform multi-frame edge-enhanced deghosting as described in more detail below. In some embodiments, this can be done to support multi-frame processing, such as HDR image generation.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, obtain and process image frames in order to perform multi-frame edge-enhanced deghosting, such as to support multi-frame processing like during HDR image generation. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the one or more sensors 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that includes one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may obtain and process image frames in order to perform multi-frame edge-enhanced deghosting as described in more detail below. In some embodiments, this can be done to support multi-frame processing, such as HDR image generation.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

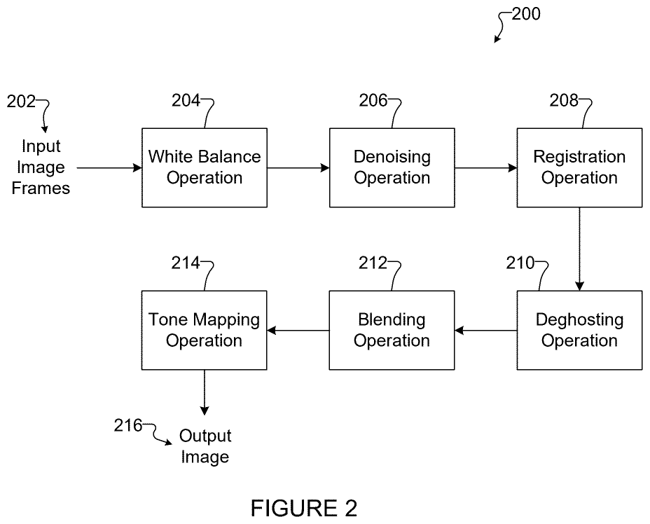

FIG. 2 illustrates an example multi-frame processing pipeline 200 that supports multi-frame edge-enhanced deghosting in accordance with this disclosure. For ease of explanation, the multi-frame processing pipeline 200 shown in FIG. 2 is described as being implemented on or supported by the electronic device 101 in the network configuration 100 of FIG. 1. However, the multi-frame processing pipeline 200 shown in FIG. 2 could be used with any other suitable device(s) and in any other suitable system(s), such as when the multi-frame processing pipeline 200 is implemented on or supported by the server 106.

As shown in FIG. 2, the multi-frame processing pipeline 200 generally receives and processes input image frames 202. The input image frames 202 may include image frames captured in rapid succession or at substantially the same time. The input image frames 202 may be obtained from any suitable source(s), such as when the input image frames 202 are captured using at least one camera or other imaging sensor 180 of the electronic device 101 during an image capture operation. Depending on the implementation, a single imaging sensor 180 may be used to capture the input image frames 202, or multiple imaging sensors 180 may be used to capture the input image frames 202.

In some embodiments, the input image frames 202 represent raw image frames. Raw image frames typically refer to image frames that have undergone little if any processing after being captured. The availability of raw image frames can be useful in a number of circumstances since the raw image frames can be subsequently processed to achieve the creation of desired effects in output images. In many cases, for example, the input image frames 202 can have a wider dynamic range or a wider color gamut that is narrowed during image processing operations in order to produce still or video image frames suitable for display or other use. The input image frames 202 here may include any suitable number of input image frames 202. Each input image frame 202 can have any suitable format, such as a Bayer or other raw image format, a red-green-blue (RGB) image format, or a luma-chroma (YUV) image format. Each input image frame 202 can also have any suitable resolution, such as up to fifty megapixels or more.

In some embodiments, the input image frames 202 include image frames captured using different capture conditions. The capture conditions can represent any suitable settings of the electronic device 101 or other device used to capture the input image frames 202. For example, the capture conditions may represent different exposure settings of the imaging sensor(s) 180 used to capture the input image frames 202, such as different exposure times or ISO settings. In multi-frame processing pipelines, multiple input image frames 202 can be captured using different exposure settings so that portions of different input image frames 202 can be combined to produce an HDR output image or other blended image.

The input image frames 202 are processed using various operations in the multi-frame processing pipeline 200. For example, each input image frame 202 may be provided to a white balance operation 204, which may perform image color adjustment in order to modify the white balance of each input image frame 202. In some cases, the white balance operation 204 can adjust the color intensities of the input image frames 202 in order to remove color casts and achieve desired color temperatures in the resulting balanced image frames. As a particular example, the white balance operation 204 may adjust the input image frames 202 so that all of the resulting balanced image frames have similar color temperatures. The white balance operation 204 may use any suitable technique(s) for performing white balance correction or other color corrections. Note, however, that this disclosure is not limited to any particular technique(s) for performing color corrections. Also note that any other or additional image pre-processing operations may be performed here.

The input image frames 202 (or the balanced versions thereof) can be provided to a denoising operation 206, which generally operates to process the image frames and remove noise from the image frames in order to generate denoised image frames. For example, the denoising operation 206 may be used to remove sampling, interpolation, and aliasing artifacts and noise in the image frames. The denoising operation 206 may also or alternatively be used to filter the image data of the image frames in order to remove noise from object edges, which can help to provide cleaner edges to objects captured in the image frames. The denoising operation 206 may use any suitable technique(s) for filtering image data, such as spatial noise filtering. Note, however, that this disclosure is not limited to any particular technique(s) for filtering image data.

The input image frames 202 (or the denoised versions thereof) can be provided to a registration operation 208, which generally operates to modify one or more of the image frames in order to generate aligned versions of the image frames. For example, the image frames may undergo alignment so that common features in different image frames are at the same or substantially the same locations in the aligned versions of the image frames. In some embodiments, the registration operation 208 may select a reference image frame and modify one or more non-reference image frames so as to be aligned with the reference image frame. In some cases, for instance, the registration operation 208 generates a warp or alignment map for each non-reference image frame, where each warp or alignment map includes or is based on one or more motion vectors that identify how the position(s) of one or more specific features in the associated non-reference image frame should be altered in order to be in the position(s) of the same feature(s) in the reference image frame. Among other reasons, alignment may be needed in order to compensate for misalignment caused by the electronic device 101 moving or rotating in between image captures, which causes objects in the input image frames 202 to move or rotate slightly (as is common with handheld devices). The registration operation 208 may use any suitable technique(s) for image alignment, which is also sometimes referred to as image registration. In some embodiments, the preprocessed input image frames 202 can be aligned both geometrically and photometrically. In particular embodiments, the registration operation 208 can use global Oriented FAST and Rotated BRIEF (ORB) features and local features from a block search to identify how to align the image frames. Note, however, that this disclosure is not limited to any particular technique(s) for aligning image frames.

The input image frames 202 (or the aligned versions thereof) can be provided to a deghosting operation 210, which generally operates to identify motion in the scene that is captured by the image frames. For example, the deghosting operation 210 may compare reference and non-reference image frames in order to identify any area(s) of the non-reference image frame(s) differing by at least a threshold amount or percentage compared to the same area(s) of the reference frame. When motion is present in at least a portion of the scene being captured, blending of multiple image frames in at least that portion of the scene may be avoided or controlled in order to reduce or prevent the creation of blur. In some cases, the deghosting operation 210 may generate at least one blend map, where each blend map identifies how image frames are to be blended. For instance, a blend map could include values that indicate a weight to be applied to a non-reference frame when blending with a reference frame. If motion is detected in a specific area of a scene, the blend map may indicate that, during blending, most or all of the image content for that specific area of the scene should come from a single image frame (such as the image frame captured using the shortest exposure). The deghosting operation 210 may use any suitable technique to identify how to blend multiple image frames to reduce or avoid the creation of motion blur. As part of this process, the deghosting operation 210 can perform multi-frame edge-enhanced deghosting as described in more detail below.

A blending operation 212 generally operates to combine image data contained in the input image frames 202 (or the aligned versions thereof) based on the blend maps generated by the deghosting operation 210. For example, the blending operation 212 may process the image frames in order to modify portions of a selected reference frame using image data from one or more non-reference frames. As a particular example, the blending operation 212 may take the reference frame and replace one or more portions of the reference frame containing motion with one or more corresponding portions of shorter-exposure image frames. As another particular example, the blending operation 212 may take the reference frame and replace one or more portions of the reference frame capturing darker areas of a scene with one or more corresponding portions of shorter-exposure image frames. These types of image data replacement or combination functions can be based on the blend maps generated by the deghosting operation 210. In some cases, the blending operation 212 may perform a weighted blending operation to combine the pixel values contained in the image frames. Note, however, that this disclosure is not limited to any particular technique(s) for combining image frames.

A resulting blended image generated by the blending operation 212 is provided to a tone mapping operation 214, which generally operates to adjust colors in the blended image. This can be useful or important in various applications, such as when generating HDR images. For example, since generating an HDR image often involves capturing multiple images of a scene using different exposures and combining the captured images to produce the HDR image, this type of processing can often result in the creation of unnatural tone within the HDR image. The tone mapping operation 214 can therefore use one or more color mappings to adjust the colors contained in the blended image. The output of the tone mapping operation 214 can represent an output image 216, which may represent a final image of the scene. The tone mapping operation 214 may use any suitable technique(s) to perform tone mapping, such as one or more global tone mapping techniques and/or one or more local tone mapping techniques. As a particular example, the tone mapping operation 214 may multiply each pixel of the blended image by a corresponding gain value to help ensure that the resulting output image 216 can be displayed appropriately. Note, however, that this disclosure is not limited to any particular technique(s) for performing tone mapping. Also note that any other or additional image post-processing operations may be performed here.

Although FIG. 2 illustrates one example of a multi-frame processing pipeline 200 that supports multi-frame edge-enhanced deghosting, various changes may be made to FIG. 2. For example, various components or operations in FIG. 2 may be combined, further subdivided, replicated, rearranged, or omitted according to particular needs. Also, various additional components or functions may be used in FIG. 2. In addition, the specific multi-frame processing pipeline 200 described above is for illustration and explanation only. Various image processing pipelines have been developed, and additional image processing pipelines are sure to be developed in the future. This disclosure is not limited to any specific implementation of an multi-frame processing pipeline 200 or even to use within an image processing pipeline. In general, the techniques for multi-frame edge-enhanced deghosting described in this patent document may be used in any other image processing pipeline or other architecture.

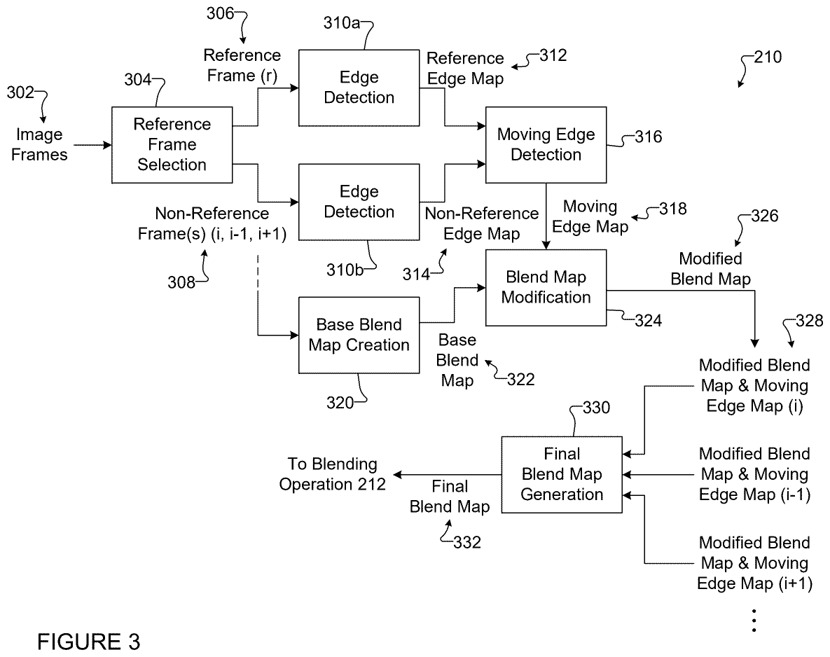

FIG. 3 illustrates an example deghosting operation 210 in the multi-frame processing pipeline 200 of FIG. 2 in accordance with this disclosure. For ease of explanation, the deghosting operation 210 shown in FIG. 3 is described as being implemented on or supported by the electronic device 101 in the network configuration 100 of FIG. 1. However, the deghosting operation 210 shown in FIG. 3 could be used with any other suitable device(s) or pipeline(s) and in any other suitable system(s), such as when the deghosting operation 210 is implemented on or supported by the server 106.

As shown in FIG. 3, image frames 302 are received as input by the deghosting operation 210. In some embodiments, the image frames 302 may represent a collection of input image frames 202, such as input image frames 202 that have been modified by the white balance operation 204, denoising operation 206, and/or registration operation 208. Thus, for instance, the image frames 302 may represent image frames that have been white balanced and registered, so all image frames 302 may have been previously mapped to the same or similar light level(s) and co-registered to a selected frame.

The image frames 302 are provided to a reference frame selection function 304, which generally operates to select a reference frame 306 from among the image frames 302. The reference frame selection function 304 may use any suitable criterion or criteria to select a reference frame 306 from among image frames 302. In some cases, for instance, the reference frame selection function 304 may estimate motion captured in each image frame 302 and select the image frame 302 capturing the smallest amount of motion as the reference frame 306. As a particular example, in some cases, the selection of the reference frame 306 can be based on the calculation of global motion percentage, such as when the global motion percentage is calculated per image block with a predefined window size within each image frame 302. During this calculation, potential motion pixels can be selected, estimated at each block using phase correlation, and further refined with a specified threshold. The image frame 302 with the lowest global motion percentage among all image frames 302 may be selected as the reference frame 306. The remainder of the image frames 302 may be treated as one or more non-reference frames 308. Note, however, that this disclosure is not limited to any particular technique(s) for selecting reference frames.

It should be noted here that other operations or functions in the multi-frame processing pipeline 200 (such as the registration operation 208) may also operate by selecting a reference frame and performing various actions using the reference frame and one or more non-reference frames. The reference frame 306 and the non-reference frame(s) 308 identified by the reference frame selection function 304 here may be the same as or different from the reference and non-reference frames used by those other operations or functions in the multi-frame processing pipeline 200. In other words, different operations or functions in the multi-frame processing pipeline 200 may or may not use the same identification of reference and non-reference frames.

The reference and non-reference frames 306, 308 are processed using one or more edge detection functions 310a-310b. Each edge detection function 310a-310b generally operates to identify object edges within the corresponding frame(s) 306, 308. For example, each edge detection function 310a-310b may identify the outer edges or other edges of people, vehicles, buildings, trees, mountains, or other contents captured in the corresponding frame(s) 306, 308. This results in the generation of a reference edge map 312, which identifies detected edges in the reference frame 306. This also results in the generation of a non-reference edge map 314 for each non-reference frame 308, where each non-reference edge map 314 identifies detected edges in the associated non-reference frame 308.

Each edge detection function 310a-310b may use any suitable technique(s) for detecting edges in image frames. In some embodiments, for instance, canny edge detection may be used. Canny edge detection can operate by finding an intensity gradient of an image frame and applying non-maximum suppression. This produces an initial binary map identifying detected edges, and additional thresholding can be used to determine whether each detected edge is real or not. Low and high thresholds used for canny edge detection may be hard-coded (such as with experimented values), based on image statistics (such as a median value of pixels), based on Otsu thresholding, or determined in any other suitable manner. In other embodiments, edge information may be extracted from image frames using a Sobel filter, a neural network or other trained machine learning model, or an edge detection technique that operates in the frequency domain (such as by using a phase stretch transform). Note, however, that this disclosure is not limited to any particular technique(s) for performing edge detection. Also note that while multiple edge detection functions 310a-310b are shown here, this is merely for ease of illustration, and the same edge detection function may be used to process the reference and non-reference frames 306, 308.

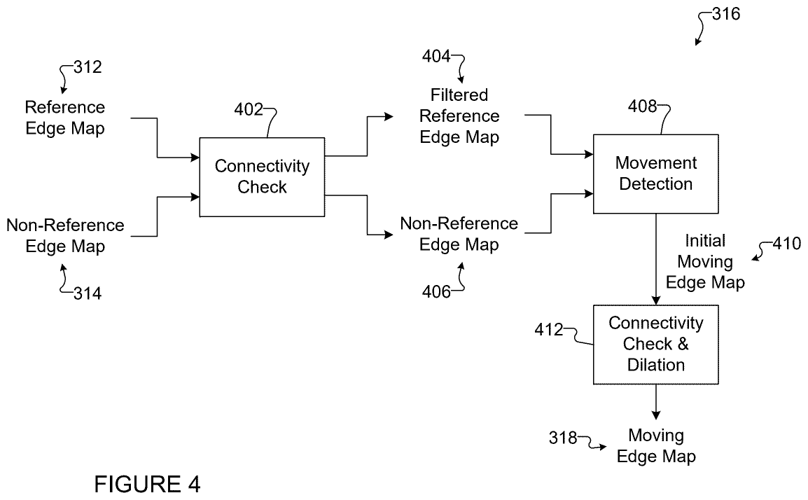

A moving edge detection function 316 receives and processes the reference and non-reference edge maps 312, 314 in order to detect moving edges within the reference and non-reference frames 306, 308. For example, the moving edge detection function 316 may compare the locations of edges in the reference edge map 312 with the locations of the same edges in each non-reference edge map 314. Based on these comparisons, the moving edge detection function 316 can generate a moving edge map 318 for each non-reference frame 308. Each moving edge map 318 can identify one or more movements between one or more of the edges of the reference edge map 312 and one or more of the edges of the associated non-reference edge map 314. The moving edge detection function 316 may use any suitable technique(s) for identifying moving edges in image frames. One example technique that may be used by the moving edge detection function 316 is shown in FIG. 4, which is described in more detail below. Note, however, that this disclosure is not limited to any particular technique(s) for performing moving edge detection.

The reference and non-reference frames 306, 308 are also processed using a base blend map creation function 320, which uses the reference and non-reference frames 306, 308 in order to generate an initial or base blend map 322. The base blend map 322 represents an initial estimation of the motion captured in the reference and non-reference frames 306, 308. In some embodiments, for instance, the base blend map 322 may have a resolution that matches the resolution of each reference and non-reference frame 306, 308, and the base blend map 322 can have pixel values within a specified range, such as pixel values ranging from zero to 255. A value of 255 may indicate that the corresponding pixel is identified as moving, and a value of 0 may indicate that the corresponding pixel is static. Values in between zero and 255 can indicate a likelihood or probability that the corresponding pixel is moving or not moving. The base blend map creation function 320 may use any suitable technique(s) for generating blend maps, such as by performing a deghosting process. Various deghosting processes may be based on a number of factors, such as local pixel differences, local edge strengths, and/or estimated noise levels. Note, however, that this disclosure is not limited to any particular technique(s) for generating initial blend maps.

The base blend map 322 and the moving edge map(s) 318 are provided to a blend map modification function 324, which generally operates to modify the base blend map 322 based on each moving edge map 318 in order to generate at least one modified blend map 326. Each modified blend map 326 represents the base blend map 322 as modified based on the moving edge map 318 for an associated non-reference frame 308. The base blend map 322 may be modified by each moving edge map 318 in any suitable manner to reflect detected movements of edges within the resulting modified blend map 326. In some embodiments, for each pixel of the base blend map 322 associated with identified movement (as defined by the corresponding moving edge map 318), the pixel value of that pixel in the base blend map 322 can be multiplied by an edge score in the moving edge map 318, which generates a corresponding pixel value for the respective pixel in the modified blend map 326. In some cases, each edge score could be based on one or more reference frame statistics, such as an average of the calculated reference edge map 312. For each pixel of the base blend map 322 that is static (meaning it is not associated with identified movement as defined by the corresponding moving edge map 318), the pixel value of that pixel in the base blend map 322 can be maintained as a corresponding static pixel value for the respective pixel in the modified blend map 326 (meaning the same pixel value from the base blend map 322 is used in the modified blend map 326). In some cases, the pixel values in each modified blend map 326 may be clipped (such as to a range of [0, 255]) after the pixel values are generated in this manner.

This process leads to the creation of one or more sets 328 of modified blend maps and corresponding moving edge maps. As described above, this process can identify one non-reference frame 308 or multiple non-reference frames 308. If a single non-reference frame 308 is identified, the various operations described above may be used to generate one set 328 having one modified blend map 326 and one moving edge map 318 for the single non-reference frame 308. If multiple non-reference frames 308 are identified, the various operations described above may be used to generate multiple sets 328 each having one modified blend map 326 and one moving edge map 318 for one of the non-reference frame 308.

In the following discussion, it is assumed that the reference frame 306 is denoted r and that a specified non-reference frame 308 to be blended with the reference frame 306 is denoted i. The non-reference frame 308 (i) is associated with a modified blend map denoted R and a moving edge map denoted E. In some cases, it is possible to utilize information across multiple adjacent non-reference frames 308 when determining how to blend the specified non-reference frame 308 (i) with the reference frame 306 (r). Here, an adjacent non-reference frame may be denoted i−1 and can be associated with a modified blend map denoted R′ and a moving edge map denoted E′, and/or an adjacent non-reference frame may be denoted i+1 and can be associated with a modified blend map denoted R″ and a moving edge map denoted E″. Note that while two adjacent non-reference frames 308 are mentioned here, one or more than two adjacent non-reference frames may be supported. The adjacent non-reference frame(s) 308 may be useful here in refining how the specified non-reference frame 308 (i) is blended with the reference frame 306 (r).

A final blend map generation function 330 can process the one or more sets 328 of maps in order to generate a final blend map 332, which defines how the reference frame 306 can be blended with the specified non-reference frame 308 (i). The final blend map generation function 330 can generate the final blend map 332 in any suitable manner, which may depend (at least in part) on the number of non-reference frames 308 being considered by the deghosting operation 210. For example, when no adjacent non-reference frames 308 are being considered, the final blend map generation function 330 may output the modified blend map 326 for the specified non-reference frame 308 (i) as the final blend map 332. When one or more adjacent non-reference frames 308 are being considered, the final blend map generation function 330 may combine the modified blend map 326 for the specified non-reference frame 308 (i) and the modified blend map(s) 326 for one or more adjacent non-reference frames 308 (such as i−1 and/or i+1) to generate the final blend map 332.

In some embodiments, the final blend map 332 may be generated in the latter scenario as follows. Each modified blend map 326 can be processed to identify where (within given blend map areas expressed using x and y coordinates) the modified blend map 326 contains values that are larger than a threshold value, thereby filtering the values in the modified blend maps 326. An initial version of the final blend map 332 may be denoted Rᵢ* and can be generated by identifying all of the largest values from any of the modified blend maps 326 remaining after the filtering and including those largest values in the initial version Rᵢ* of the final blend map 332. A dilation may be performed on the moving edge maps 318 associated with the modified blend maps 326. Dilation is an operation that “thickens” edges, such as by taking the maximum value in an N×N window surrounding each pixel and using that maximum value for the pixel. By performing dilation on the moving edge maps 318 and summing the resulting dilated moving edge maps 318, it is possible to define an intersection area (expressed using a and b coordinates) at locations where the sum is greater than a specified threshold. An intersection area value can be scaled (such as to a value in a range of [0,1]), and each value in the initial version

$${R}_{i}^{*}$$

of the final blend map 332 can be multiplied with the corresponding scaled interaction area value, the corresponding edge score, and a specified multiplier to generate an updated version of the final blend map 332 that can be denoted

$${R}_{i}^{**} .$$

In some cases, the specified multiplier may be in a range of [1, 2]. The maximum pixel value between

$${R}_{i}^{*} and {R}_{i}^{**}$$

may be selected to generate the final blend map 332 that can be denoted Rᵢ, and the final blend map 332 may be clipped (such as to a range of [0, 255]) and normalized (such as to a range of [0,1]). If desired, other or additional post-processing may occur to generate the final blend map 332.

The final blend map 332 can be provided to the blending operation 212, which can blend the reference frame 306 and the specified non-reference frame 308 (i) based on the final blend map 332. For example, in some embodiments, the blending operation 212 may perform weighted blended of the reference frame 306 and the specified non-reference frame 308 (i) based on weights contained in the final blend map 332, such as by applying the weights to the specified non-reference frame 308 (i) and adding the results to the reference frame 306. Note that the process described here can be used to blend the reference frame 306 with a single non-reference frame 308 or to blend the reference frame 306 with multiple non-reference frames 308. If the reference frame 306 is to be blended with multiple non-reference image frames 308, the final blend map generation function 330 may be used to generate multiple final blend maps 332 in the manner described above, such as one final blend map 332 for each non-reference image frame 308. Thus, in some embodiments, the blending operation 212 may perform weighted blended of the reference frame 306 and the multiple non-reference frames 308 based on weights contained in the final blend maps 332, such as by applying the weights in each final blend map 332 to the corresponding non-reference frame 308 and adding the results to the reference frame 306.

In some embodiments, the final blend map 332 for the specified non-reference frame 308 (i) may be denoted as Rᵢ. If generated, the final blend map 332 for the adjacent non-reference frame 308 (i−1) may be denoted as Rᵢ₋₁, and/or the final blend map 332 for the adjacent non-reference frame 308 (i+1) may be denoted as Rᵢ₊₁. A blended image generated by the blending operation 212 may be expressed as follows.

$$Blended Image = r + \frac{1}{N} ( i \times {R}_{i} + ( i - 1 ) \times {R}_{i - 1} + ( i + 1 ) \times {R}_{i + 1} + … )$$

Here, N represents the number of non-reference image frames 308. This indicates that the blended image produced by the blending operation 212 represents a combination of the reference frame 306 (r) and a weighted version of each non-reference frame 308, where each non-reference frame 308 is weighted by the weights of its associated final blend map 332. If there is a single non-reference frame 308, the blended image produced by the blending operation 212 represents a combination of the reference frame 306 (r) and a weighted version of the single non-reference frame 308 (i) as weighted by its associated final blend map 332 (Rᵢ). If there are multiple non-reference frames 308, the blended image produced by the blending operation 212 represents a combination of the reference frame 306 (r) and a weighted version of each non-reference frame 308 (i, i−1, i+1, etc.) as weighted by its associated final blend map 332 (Rᵢ, Rᵢ₋₁, Rᵢ₊₁, etc.).

In this way, the deghosting operation 210 shown in FIG. 3 uses moving edge detection as part of the deghosting process, which provides for improved motion detection, such as with foliage or other objects having finer textures. Among other things, the deghosting operation 210 can be used to detect edges presented in pairs of reference and non-reference frames 306, 308, identify edges that should be classified as being in motion, and correct base blend maps 322 using the detected moving edges. Optionally, the final blend map 332 for each non-reference frame 308 may be generated using multi-way deghosting based on one or more adjacent non-reference frames 308 in order to utilize information across the adjacent non-reference frames 308 to enhance the deghosting process. Thus, for instance, a specified non-reference frame 308 and one or more adjacent non-reference frames 308 may be selected and used with the reference frame 306 to calculate modified blend maps 326 as described above, and the modified blend maps 326 may be compared or otherwise used to correct or enhance the final blend map 332 generated for the specified non-reference frame 308.

Although FIG. 3 illustrates one example of a deghosting operation 210 in the multi-frame processing pipeline 200 of FIG. 2, various changes may be made to FIG. 3. For example, various components or functions in FIG. 3 may be combined, further subdivided, replicated, rearranged, or omitted according to particular needs. Also, various additional components or functions may be used in FIG. 3. In addition, while the consideration of a specified non-reference frame 308 (i) and two adjacent non-reference frames 308 (i−1 and i+1) is often described above, it is possible to expand this process and consider more than two adjacent non-reference frames 308.

FIG. 4 illustrates an example moving edge detection function 316 in the deghosting operation 210 of FIG. 3 in accordance with this disclosure. For ease of explanation, the moving edge detection function 316 shown in FIG. 4 is described as being implemented on or supported by the electronic device 101 in the network configuration 100 of FIG. 1. However, the moving edge detection function 316 shown in FIG. 4 could be used with any other suitable device(s) or pipeline(s) and in any other suitable system(s), such as when the moving edge detection function 316 is implemented on or supported by the server 106.

As shown in FIG. 4, the moving edge detection function 316 can receive a reference edge map 312 and a non-reference edge map 314. It is assumed here that a single non-reference edge map 314 is generated and processed by the moving edge detection function 316. However, as noted above, the moving edge detection function 316 could receive and process multiple non-reference edge map 314 in the same or similar manner. The moving edge detection function 316 may initially filter the edges of the reference edge map 312 and the edges of the non-reference edge map 314, such as by removing those edges that have a length below a specified threshold. In this example, the moving edge detection function 316 includes a connectivity check function 402, which can perform a connectivity check on the reference edge map 312 and the non-reference edge map 314 to filter out detected edges having lengths below the specified threshold. As a particular example, the connectivity check function 402 may examine a 3×3 neighborhood or other pixel neighborhood around each selected pixel in the reference edge map 312 or the non-reference edge map 314, and pixels may be considered as being connected (thereby forming an edge) if their sides or corners touch. Two pixels may be classified as part of the same object edge if they are both on and are connected along a horizontal, vertical, or diagonal direction. This results in the generation of a filtered reference edge map 404 and a filtered non-reference edge map 406.

After filtering, one or more movements of one or more edges between the filtered reference edge map 404 and the filtered non-reference edge map 406 may be identified using a movement detection function 408. For example, the movement detection function 408 can process the filtered reference edge map 404 and the filtered non-reference edge map 406 to determine when an edge in the filtered reference edge map 404 and the same edge in the filtered non-reference edge map 406 have different positions in the filtered edge maps 404, 406. In some cases, the movement detection function 408 may identify moving edges based on a non-zero area of a difference between the corresponding edges of the filtered reference and non-reference edge maps 404, 406. In other words, a moving edge is detected by identifying a non-zero area between the location of the edge in the filtered reference edge map 404 and the location of the same edge in the filtered non-reference edge map 406. This leads to the generation of an initial moving edge map 410, which can identify all locations in which edges move between the filtered reference and non-reference edge maps 404, 406.

A connectivity check and dilation function 412 can be applied to the initial moving edge map 410 in order to refine the initial moving edge map 410 and generate a moving edge map 318. For example, the connectivity check and dilation function 412 can perform a second connectivity check on the initial moving edge map 410, such as to filter out small moving edges (which may tend to represent false-detected moving edges) from the initial moving edge map 410. The connectivity check and dilation function 412 can also perform the dilation operation to increase the thicknesses of at least some of the edges in the initial moving edge map 410. In some cases, for instance, dilation can be performed on any edges from the initial moving edge map 410 that were not filtered as a result of the second connectivity check. The remaining thickened edges may be used to generate the moving edge map 318. In some embodiments, the moving edge map 318 may represent a binary map in which each pixel has one value indicating that an edge is present or another value indicating that an edge is not present.

Although FIG. 4 illustrates one example of a moving edge detection function 316 in the deghosting operation 210 of FIG. 3, various changes may be made to FIG. 4. For example, various components or functions in FIG. 4 may be combined, further subdivided, replicated, rearranged, or omitted according to particular needs. Also, various additional components or functions may be used in FIG. 4. In addition, moving edge detection may be performed in any other suitable manner.

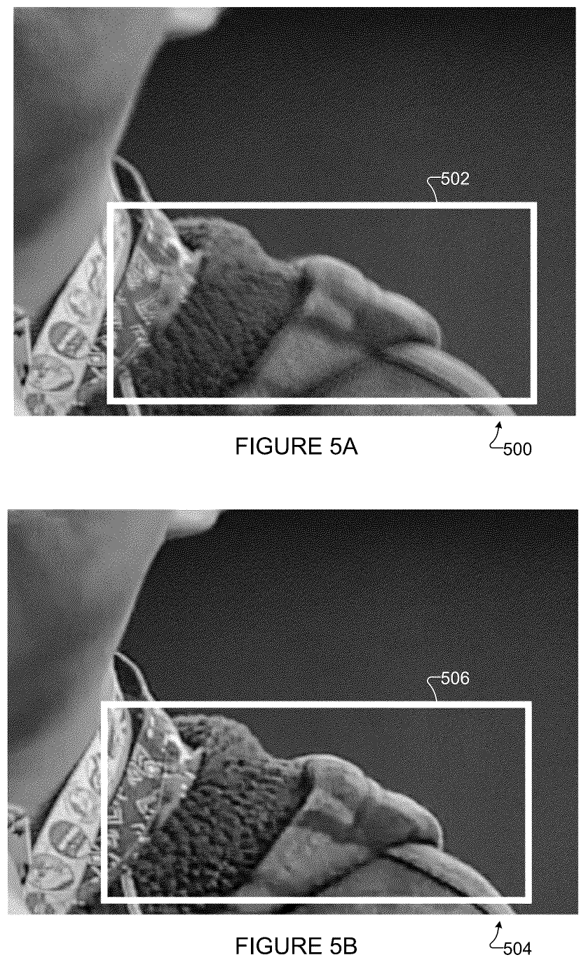

FIGS. 5A and 5B illustrate example results obtainable using multi-frame edge-enhanced deghosting in accordance with this disclosure. More specifically, FIG. 5A illustrates part of an example output image 500 that could be generated using a multi-frame pipeline without multi-frame edge-enhanced deghosting. As can be seen here, a portion 502 of the image 500 is quite blurry. This may be caused (among other things) by incorrect or poor deghosting, such as due to an inability to properly identify small amounts of motion for objects having finer textures (like the person's shirt and jacket).

In contrast, FIG. 5B illustrates part of an example output image 504 that could be generated using the multi-frame processing pipeline 200, which supports multi-frame edge-enhanced deghosting. As can be seen here, a portion 506 of the image 504 is much clearer compared to the portion 502 of the image 500. This may be allowed (among other things) by the ability to properly identify moving edges in the scene and perform deghosting based on the moving edges. The resulting output image 504 may therefore include cleaner details, particularly for smaller textures or other details within the scene being imaged.

Although FIGS. 5A and 5B illustrate one example of results obtainable using multi-frame edge-enhanced deghosting, various changes may be made to FIGS. 5A and 5B. For example, FIGS. 5A and 5B are merely meant to illustrate one example of a type of benefit that might be obtained using the techniques of this disclosure. The specific results that are obtained in any given situation can vary based on the circumstances and based on the specific implementation of the techniques described in this disclosure.

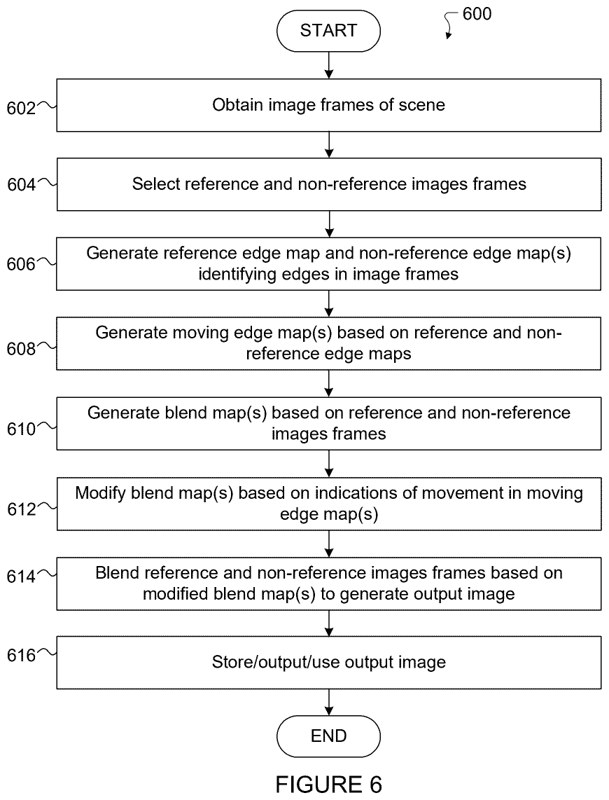

FIG. 6 illustrates an example method 600 for multi-frame edge-enhanced deghosting in accordance with this disclosure. For ease of explanation, the method 600 shown in FIG. 6 is described as being performed by the electronic device 101 in the network configuration 100 of FIG. 1, where the electronic device 101 can implement the pipeline 200 shown in FIG. 2. However, the method 600 shown in FIG. 6 could be performed by any other suitable device(s) and pipeline(s) and in any other suitable system(s), such as when the method 600 is performed using the server 106.

As shown in FIG. 6, image frames of a scene are obtained at step 602. This may include, for example, the processor 120 of the electronic device 101 generating or otherwise obtaining multiple image frames 202, 302 of the scene. If needed or desired, this may also include pre-processing the image frames, such as by processing the input image frames 202 using the white balance operation 204, the denoising operation 206, and/or the registration operation 208 to generate the image frames 302. Reference and non-reference image frames are selected from among the image frames at step 604. This may include, for example, the processor 120 of the electronic device 101 performing the reference frame selection function 304 of the deghosting operation 210 to select a reference frame 306 from among the image frames 202, 302. In some cases, the reference frame 306 may be selected as having the smallest amount of global motion. Also, any image frame 202, 302 not selected as the reference frame 306 may be treated as a non-reference frame 308.

Reference and non-reference edge maps are generated at step 606. This may include, for example, the processor 120 of the electronic device 101 performing the edge detection function(s) 310a-310b of the deghosting operation 210 to generate a reference edge map 312 and at least one non-reference edge map 314. The reference edge map 312 identifies edges in the selected reference frame 306, and each non-reference edge map 314 identifies edges in a corresponding non-reference frame 308. At least one moving edge map is generated based on the reference and non-reference edge maps at step 608. This may include, for example, the processor 120 of the electronic device 101 performing the moving edge detection function 316 of the deghosting operation 210 to identify one or more movements between one or more edges of the reference edge map 312 and one or more edges of each non-reference edge map 314 in order to generate one or more moving edge maps 318. In some cases, this can involve filtering the edges of the reference edge map 312 and the edges of each non-reference edge map 314 that have a length below a threshold and identifying one or more movements based on a non-zero area of a difference between corresponding edges of the filtered reference edge map 404 and each filtered non-reference edge map 406.

At least one blend map is generated based on the reference and non-reference frames at step 610. This may include, for example, the processor 120 of the electronic device 101 performing the base blend map creation function 320 to create at least one base blend map 322 that identifies motion between the reference frame 306 and each non-reference frame 308. In some cases, the base blend map creation function 320 may use standard or other deghosting to identify the at least one base blend map 322. Each blend map is modified based on indications of movement contained in a corresponding moving edge map at step 612. This may include, for example, the processor 120 of the electronic device 101 performing the blend map modification function 324 to modify each base blend map 322 based on the associated moving edge map 318 in order to generate one or more modified blend maps 326. As a particular example, for each identified movement of a respective pixel in a moving edge map 318, a pixel value for the respective pixel in the corresponding base blend map 322 may be multiplied by an edge score in the moving edge map 318 to generate a corresponding pixel value for the respective pixel in the corresponding modified blend map 326. For each static pixel identified in a moving edge map 318, a pixel value for the static pixel may be maintained in the corresponding modified blend map 326.

The reference frame and the non-reference frame(s) are blended based on the modified blend map(s) to generate an output image at step 614. This may include, for example, the processor 120 of the electronic device 101 performing the final blend map generation function 330 to generate at least one final blend map 332. In some cases, the final blend map 332 for a non-reference frame 308 may be generated by selecting a final pixel value for a respective pixel based on a highest pixel value between (i) a pixel value of the respective pixel in the modified blend map 326 for that non-reference frame 308 and (ii) a pixel value of the respective pixel in at least one modified blend map 326 for at least one adjacent non-reference frame 308. Also, in some cases, dilation may be performed on the moving edge map 318 of a non-reference frame 308 and the moving edge map 318 of each adjacent non-reference frame 308 to determine an intersection area value, and the final blend map 332 may be generated by multiplying the final pixel value by an intersection area value. This may also include the processor 120 of the electronic device 101 performing the blending operation 212 to perform weighted blending of the reference and non-reference frames 306, 308. The blended image may optionally undergo one or more post-processing operations, and the blended image or the post-processed version thereof can represent an output image 216.

The output image is stored, output, or used in some manner at step 616. For example, the output image 216 may be displayed on the display 160 of the electronic device 101, saved to a camera roll stored in a memory 130 of the electronic device 101, or attached to a text message, email, or other communication to be transmitted from the electronic device 101. Of course, the output image 216 could be used in any other or additional manner.

Although FIG. 6 illustrates one example of a method 600 for multi-frame edge-enhanced deghosting, various changes may be made to FIG. 6. For example, while shown as a series of steps, various steps in FIG. 6 may overlap, occur in parallel, occur in a different order, or occur any number of times (including zero times). As a particular example, various steps in FIG. 6 may be repeated for each of multiple non-reference frames 308, and the blending in step 614 may combine the reference frame 306 with the multiple non-reference frames 308.

It should be noted that the functions described above can be implemented in an electronic device 101, 102, 104, server 106, or other device(s) in any suitable manner. For example, in some embodiments, at least some of the functions can be implemented or supported using one or more software applications or other software instructions that are executed by the processor 120 of the electronic device 101, 102, 104, server 106, or other device(s). In other embodiments, at least some of the functions can be implemented or supported using dedicated hardware components. In general, the functions described above can be performed using any suitable hardware or any suitable combination of hardware and software/firmware instructions. Also, the functions described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
selecting, using at least one processing device of an electronic device, a reference frame and a non-reference frame from a plurality of image frames;
generating, using the at least one processing device, a reference edge map identifying edges in the reference frame and a non-reference edge map identifying edges in the non-reference frame;
generating, using the at least one processing device, a moving edge map based on one or more movements between one or more of the edges of the reference edge map and one or more of the edges of the non-reference edge map;
generating, using the at least one processing device, a blend map based on the reference frame and the non-reference frame;
modifying, using the at least one processing device, the blend map based on one or more indications of movement of corresponding pixels in the moving edge map to generate a modified blend map; and
blending, using the at least one processing device, the reference frame and the non-reference frame based on the modified blend map to generate an output image.

2. The method of claim 1, wherein generating the moving edge map comprises:
filtering the edges of the reference edge map and the edges of the non-reference edge map that have a length below a threshold; and
identifying the one or more movements based on a non-zero area of a difference between corresponding edges of the reference edge map and the non-reference edge map.

3. The method of claim 1, wherein modifying the blend map comprises:
for each identified movement of a respective pixel in the moving edge map, multiplying a pixel value for the respective pixel in the blend map by an edge score in the moving edge map to generate a corresponding pixel value for the respective pixel in the modified blend map.

4. The method of claim 3, wherein modifying the blend map further comprises:
for each static pixel identified in the moving edge map, maintaining a pixel value for the static pixel in the modified blend map.

5. The method of claim 1, further comprising:
selecting a second non-reference frame from the plurality of image frames;
generating a second non-reference edge map identifying edges in the second non-reference frame;
generating a second moving edge map based on at least one movement between at least one of the edges of the reference edge map and at least one of the edges of the second non-reference edge map;
generating a second blend map based on the reference frame and the second non-reference frame; and
modifying the second blend map based on at least one indication of movement of corresponding pixels in the second moving edge map to generate a second modified blend map; and
wherein blending the reference frame and the non-reference frame comprises blending the reference frame, the non-reference frame weighted by the modified blend map, and the second non-reference frame weighted by the second modified blend map.

6. The method of claim 5, further comprising:
generating a final blend map for the non-reference frame by selecting a final pixel value for a respective pixel based on a highest pixel value between (i) a pixel value of the respective pixel in the modified blend map and (ii) a pixel value of the respective pixel in a modified blend map of an adjacent non-reference frame;
wherein blending the non-reference frame weighted by the modified blend map comprises blending the non-reference frame weighted by the final blend map.

7. The method of claim 6, further comprising:
performing dilation on the moving edge map of the non-reference frame and the moving edge map of the adjacent non-reference frame to determine an intersection area value;
wherein generating the final blend map comprises multiplying the final pixel value by the intersection area value.

8. An apparatus comprising:
at least one processing device configured to:
select a reference frame and a non-reference frame from a plurality of image frames;
generate a reference edge map identifying edges in the reference frame and a non-reference edge map identifying edges in the non-reference frame;
generate a moving edge map based on one or more movements between one or more of the edges of the reference edge map and one or more of the edges of the non-reference edge map;
generate a blend map based on the reference frame and the non-reference frame;
modify the blend map based on one or more indications of movement of corresponding pixels in the moving edge map to generate a modified blend map; and
blend the reference frame and the non-reference frame based on the modified blend map to generate an output image.

9. The apparatus of claim 8, wherein, to generate the moving edge map, the at least one processing device is configured to:
filter the edges of the reference edge map and the edges of the non-reference edge map that have a length below a threshold; and
identify the one or more movements based on a non-zero area of a difference between corresponding edges of the reference edge map and the non-reference edge map.

10. The apparatus of claim 8, wherein, to modify the blend map, the at least one processing device is configured, for each identified movement of a respective pixel in the moving edge map, to multiply a pixel value for the respective pixel in the blend map by an edge score in the moving edge map to generate a corresponding pixel value for the respective pixel in the modified blend map.

11. The apparatus of claim 10, wherein, to modify the blend map, the at least one processing device is further configured, for each static pixel identified in the moving edge map, to maintain a pixel value for the static pixel in the modified blend map.

12. The apparatus of claim 8, wherein the at least one processing device is further configured to:
select a second non-reference frame from the plurality of image frames;
generate a second non-reference edge map identifying edges in the second non-reference frame;
generate a second moving edge map based on at least one movement between at least one of the edges of the reference edge map and at least one of the edges of the second non-reference edge map;
generate a second blend map based on the reference frame and the second non-reference frame; and
modify the second blend map based on at least one indication of movement of corresponding pixels in the second moving edge map to generate a second modified blend map; and
wherein, to blend the reference frame and the non-reference frame, the at least one processing device is configured to blend the reference frame, the non-reference frame weighted by the modified blend map, and the second non-reference frame weighted by the second modified blend map.

13. The apparatus of claim 12, wherein:
the at least one processing device is further configured to generate a final blend map for the non-reference frame;
to generate the final blend map for the non-reference frame, the at least one processing device is configured to select a final pixel value for a respective pixel based on a highest pixel value between (i) a pixel value of the respective pixel in the modified blend map and (ii) a pixel value of the respective pixel in a modified blend map of an adjacent non-reference frame; and
to blend the non-reference frame weighted by the modified blend map, the at least one processing device is configured to blend the non-reference frame weighted by the final blend map.

14. The apparatus of claim 13, wherein:
the at least one processing device is further configured to perform dilation on the moving edge map of the non-reference frame and the moving edge map of the adjacent non-reference frame to determine an intersection area value; and
to generate the final blend map, the at least one processing device is configured to multiply the final pixel value by the intersection area value.

15. A non-transitory machine-readable medium containing instructions that when executed cause at least one processor to:
select a reference frame and a non-reference frame from a plurality of image frames;
generate a reference edge map identifying edges in the reference frame and a non-reference edge map identifying edges in the non-reference frame;
generate a moving edge map based on one or more movements between one or more of the edges of the reference edge map and one or more of the edges of the non-reference edge map;
generate a blend map based on the reference frame and the non-reference frame;
modify the blend map based on one or more indications of movement of corresponding pixels in the moving edge map to generate a modified blend map; and
blend the reference frame and the non-reference frame based on the modified blend map to generate an output image.

16. The non-transitory machine-readable medium of claim 15, wherein the instructions that when executed cause the at least one processor to generate the moving edge map comprise instructions that when executed cause the at least one processor to:
filter the edges of the reference edge map and the edges of the non-reference edge map that have a length below a threshold; and
identify the one or more movements based on a non-zero area of a difference between corresponding edges of the reference edge map and the non-reference edge map.

17. The non-transitory machine-readable medium of claim 15, wherein the instructions that when executed cause the at least one processor to modify the blend map comprise instructions that when executed cause the at least one processor to:
for each identified movement of a respective pixel in the moving edge map, multiply a pixel value for the respective pixel in the blend map by an edge score in the moving edge map to generate a corresponding pixel value for the respective pixel in the modified blend map; and
for each static pixel identified in the moving edge map, maintain a pixel value for the static pixel in the modified blend map.

18. The non-transitory machine-readable medium of claim 15, further containing instructions that when executed cause the at least one processor to:
select a second non-reference frame from the plurality of image frames;
generate a second non-reference edge map identifying edges in the second non-reference frame;
generate a second moving edge map based on at least one movement between at least one of the edges of the reference edge map and at least one of the edges of the second non-reference edge map;
generate a second blend map based on the reference frame and the second non-reference frame; and
modify the second blend map based on at least one indication of movement of corresponding pixels in the second moving edge map to generate a second modified blend map; and
wherein the instructions that when executed cause the at least one processor to blend the reference frame and the non-reference frame comprise instructions that when executed cause the at least one processor to blend the reference frame, the non-reference frame weighted by the modified blend map, and the second non-reference frame weighted by the second modified blend map.

19. The non-transitory machine-readable medium of claim 18, further containing instructions that when executed cause the at least one processor to generate a final blend map for the non-reference frame by selecting a final pixel value for a respective pixel based on a highest pixel value between (i) a pixel value of the respective pixel in the modified blend map and (ii) a pixel value of the respective pixel in a modified blend map of an adjacent non-reference frame;
wherein the instructions that when executed cause the at least one processor to blend the non-reference frame weighted by the modified blend map comprise instructions that when executed cause the at least one processor to blend the non-reference frame weighted by the final blend map.

20. The non-transitory machine-readable medium of claim 19, further containing instructions that when executed cause the at least one processor to perform dilation on the moving edge map of the non-reference frame and the moving edge map of the adjacent non-reference frame to determine an intersection area value;
wherein the instructions that when executed cause the at least one processor to generate the final blend map comprise instructions that when executed cause the at least one processor to multiply the final pixel value by the intersection area value.
